(19) United States
(12) Patent Application Publication
(10) Pub. No.: US 2016/0284256 A1
(43) Pub. Date: Sep. 29, 2016

(54) Airborne Advertising Platform

(71) Applicant: Arthur Wigell, Warrnambool (AU)

(72) Inventor: Arthur Wigell, Warrnambool (AU)

(21) Appl. No.: 14/672,177

(22) Filed: Mar. 29, 2015

(51) Int. Cl. G09F 21/06; G05D 1/00; G03B 21/14; B64C 39/02

(52) U.S. Cl. CPC G09F 21/06; B64C 39/024; G05D 1/0027; G03B 21/14; B64C 2201/027; B64C 2201/12; B64C 2201/146

(57) ABSTRACT

An airborne mobile advertising system for visual information dissemination. The invention comprises remote controlled drones singly or as multiple units configured to carry payloads of computer controlled high intensity light emission systems. The high intensity light emission systems typically use lasers to project letters, symbols, numbers and graphics on to both man made and natural structures such as trees. Projections can also be made onto atmospheric phenomena such as fog, smoke or cloud formations. The invention includes a remote operated drone(s) which project an image via a high intensity light emission system. The light emission system can be programmed before flight or by remote operation from ground based control.

### CROSS-REFERENCES TO RELATED APPLICATIONS

Not Applicable

### STATEMENT REGARDING FEDERALLY SPONSORED RESEARCH OR DEVELOPMENT

Not Applicable

### MICROFICHE APPENDIX

Not Applicable

### BACKGROUND OF THE INVENTION

1. Field of Invention

This invention relates to the field of graphic projection displays for advertising and information dissemination. More specifically, the invention provides for a non static mobile advertising platform using drone technology.

2. Description of the Related Art.

There are many known devices used in information dissemination for the purpose of advertising using visual displays. Prior art lies in the field of fixed projected video graphic displays used on buildings and non-fixed in the form of blimps and aerial displays including aerial sign-writing.

In recent years, visual displays have been used to project images on structures and at entertainment centers from a fixed source often involving lasers or high intensity projectors. These are traditionally controlled by computer programs to produce the desired affect. These lights are physically static in nature and their positions generally do not change.

The present invention seeks to provide an improvement in non fixed means of information dissemination using light projection via an aerial platform using single or multiple platforms synced to provide a multitude of projections on solid objects or variations in atmospheric conditions such as fog, smoke or clouds.

### BRIEF SUMMARY OF THE PRESENT INVENTION

The present invention comprises an airborne mobile advertising platform using current drone technology. A high intensity light emission source is configured to be mounted onto the frame of drone with power being supplied by battery system on drone. An on board computer can be programmed to operate projection graphics system or projection graphics system can be remotely controlled from ground station. The projection of graphics and images is via a fibre optic line to projector mounted on gimbal. A GPS signal identifies location of drone in three dimensional space commonly used in present drone technology transmitting signal to ground station.

Control features are preferably provided so that the user can remotely control flight and projection display emitted from drone and adjust gimbal. Control features are present to allow synchronized flight of multiple drones to expand and combine images from all sources.

### BRIEF DESCRIPTION OF THE SEVERAL VIEWS OF THE DRAWINGS

FIG. 1 is a side view showing the present invention

FIG. 2 is an exploded perspective, showing drone separated from transceiver modules, battery, light projection system and gimbal arrangement

FIG. 3 is a block diagram showing drone controlled by ground station transceiver and remote computer graphic display interface.

FIG. 4 Shows front view of gimbal arrangement for image projection system.

FIG. 5 shows side views of multiple drones combining projected image onto object to create single image.

### REFERENCE NUMERALS IN THE DRAWINGS

1 Drone body

2 GPS receiver

3 Arm and rotor of drone

4 Transceiver module for control drone flight

5 Transceiver module for control light projection display

6 Computer interface between transceiver and light projection unit

7 Battery power system

8 Light projection system

9 Fiber Optic line

10 Image Projector

11 Gimbal

12 Multiple Drones

13 Image projection on object

14 Ground station telemetry

15 Remote controller drone flight

16 Remote controller drone flight

17 Remote control gimbal operation

18 Remote control graphic projection display

19 Remote control computer interface

20 Remote Computer graphic display controller on drone

### DETAILED DESCRIPTION OF THE INVENTION

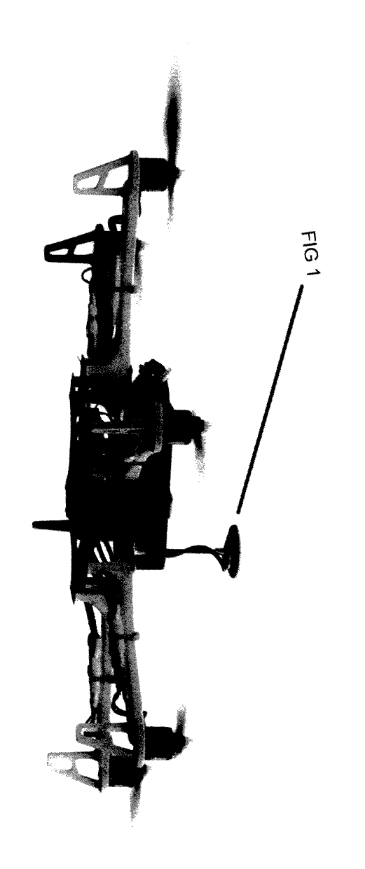

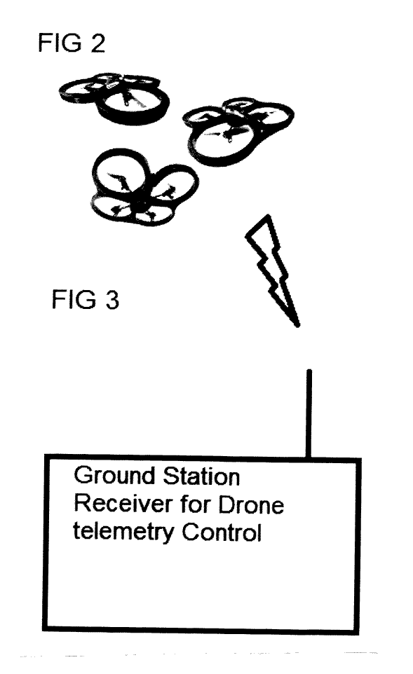

FIG. 1 shows a side view of the present invention in an assembled state. Airborne advertising platform contains various components. The drone represented in this application consists of Drone body 1, gps receiver, arm and rotor 3, transceiver module for control of drone flight 4, transceiver module for control light projection display 5, computer interface between transceiver and light projection unit 6 for control of image production, battery pack for power 7, light projection system 8, fibre optic conduit to transfer image via flexible line 9, actual image projector 10, associated gimbal mechanism to vary direction and angle of image projection FIG. 2 (11). FIG. 2 presents an exploded perspective view, showing individual components. More particularly showing gimbal arrangement 11 and arm attaching gimbal to drone. The image projector is represented by 10.

In one embodiment of this invention the on board computer 6 is programmed to provide the desired image production from the light projection display unit 5 before fight. In another embodiment of this invention, a ground based station FIG. 3 has a remote computer graphic display controller 20 interfaced with ground station telemetry 14. This configuration allows control and production of projected images during flight on an active on going basis as opposed to a pre programmed display.

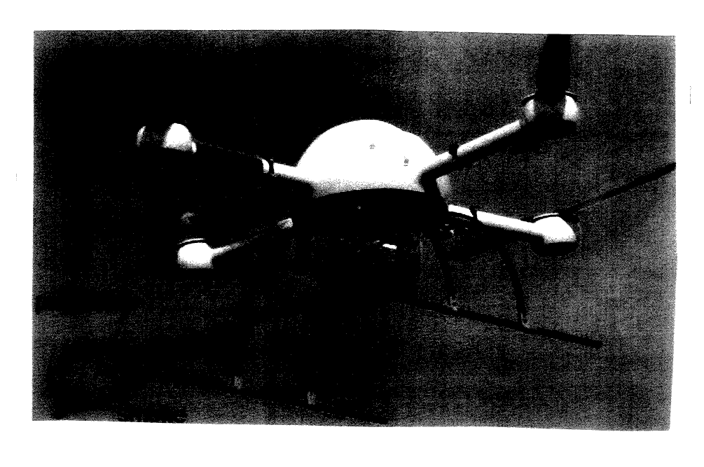

One embodiment of invention uses high intensity light lasers of varying wavelengths but more typically green laser for image projection. This can be any high intensity light that will enable projection onto object be it sold or gaseous. FIG. 4 (13) FIG. 4 shows another embodiment of invention using multiple drones for image projection 12. Three drones are shown in FIG. 4 but these numbers are unlimited only by airspace and practicality. Drones can be manipulated into position by ground control telemetry FIG. 3 thereby allowing image projection onto objects from multiple drones. This allows graphic projection displays for advertising and information dissemination. By combining multiple drone projection sources, images can be larger and or combined providing better visual presentation. Thereby, multiple drone platforms can be synced to provide a multitude of projections on solid objects or variations in atmospheric conditions such as fog, smoke or clouds.

According to this invention, the ground station FIG. 3 (14) receives data in short burst sequences from each drone of coordinates and speed using standard known technology from each drones' on board transmitter FIG. 1 (4) and gps coordinates. This allows locating each drones relationship to one another in three dimensional space FIG. 4. The ground station FIG. 3 (14) can then adjust positions of each drone by responding to this transmission sending correcting telemetry to the drones receiver FIG. 1 (2) and on board computer (4) allowing for flight corrections. This allows one to place multiple drones in a pre-planned flight pattern for the purpose of this invention.

FIG. 5 is front facing view of gimbal 11 and image projector 10. FIG. 2 is also a representative view of dismantled components. Item 12 is armature which attaches to drone body from which gimbal 11 is attached. Movement of gimbal is controlled from ground station via remote telemetry and remote control of gimbal motor 17. The operation of gimbal systems is well known technology but this is novel use of technology on an aerial display platform driving a remote image projector.

A variety of user controls for remote control operation of drones may be provided allowing greater control over drone flight, image display and projector position.

The claims defining this invention are as follows:

1. Drone providing stable mobile advertising platform for light emitting projection display.

2. Linked synchronised drones providing stable and mobile platform for light emitting projection display enabling larger and versatile projections.

3. Device to allow aerial mobile projection onto fixed and moving structures both natural and man-made.

4. Ground based interface to control single or multiple array of drones in flight

5. Ground based interface to control gimbal of airborne projection system on drone.
